(19) United States
(12) Patent Application Publication
(10) Pub. No.: US 2026/0276994 A1
(43) Pub. Date: Sep. 17, 2026

(54) HEAD MOUNTED DISPLAY DEVICE AND METHOD OF WEARING DETECTION

(71) Applicants: Fu Tai Hua Industry (Shenzhen) Co., Ltd., Shenzhen (CN); HON HAI PRECISION INDUSTRY CO., LTD., New Taipei (TW)

(72) Inventor: XIANG HUANG, Shenzhen (CN)

(21) Appl. No.: 19/440,867

(22) Filed: Jan. 6, 2026

(30) Foreign Application Priority Data
Mar. 11, 2025 (CN) 202510289075.4

(51) Int. Cl. G02B 27/01; G02B 27/00

(52) U.S. Cl. CPC G02B 27/0172; G02B 27/0093; G02B 27/0176; G02B 27/0179; G02B 2027/0138; G02B 2027/014; G02B 2027/0154; G02B 2027/0187

(57) ABSTRACT

The present application provides a head mounted display (HMD) device and a method of wearing detection. In the HMD device, an eye tracking module captures an eyes image at a time point as a real-time eyes image. A processing module calculates an offset distance between a center of a pupil of each eye in the real-time eyes image and a center of a pupil of each eye in a standard eyes image, and calculates an angle between a first imaginary line in the real-time eyes image and a second imaginary line in the standard eyes image. In a condition that, the offset distance is larger than a predefined distance threshold and/or the angle is larger than a predefined angle threshold, adjustment prompting information is outputted, for prompting the user to adjust a wearing position of the HMD device. A comfortable wearability and a display effect of the HMD are improved.

### TECHNICAL FIELD

The present application generally relates to head mounted display device technology, and particularly to a head mounted display device and a method of wearing detection.

### BACKGROUND

In scenes of virtual reality (VR), augmented reality (AR), mixed reality (MR), or extended reality (XR), users wear a head mounted display (HMD) device for watching images displayed in the HMD device, therefore an interactive immersive experience is achieved.

However, if the HMD device is worn offset, it is hard to present the images with near and far objects as in a reality word, and it is hard to determine a relative distance of the object. Further, it is easily to cause the user to experience uncomfortable symptoms, such as visual fatigue and dizziness, thereby affecting the user experience.

There is room for improvement in the art.

### BRIEF DESCRIPTION OF THE DRAWINGS

Implementations of the present application will now be described, by way of example only, with reference to the attached figures.

FIG. 1 is a diagram of an application environment of an embodiment of a head mounted display (HMD) device according to the present application.

FIG. 2 is a block diagram of an embodiment of the HMD device shown in FIG. 1.

FIG. 3 is a block diagram of an embodiment of a display module of the HMD device shown in FIG. 1, viewed from a front elevational by an user according to the present application.

FIG. 4 is a diagram of a real-time eyes image captured by an embodiment of an eye tracking module of the HMD device at a time point t1 shown in FIG. 1 according to the present application.

FIG. 5 is a diagram of an embodiment of a standard eyes image stored in the HMD device as shown in FIG. 1 according to the present application.

FIG. 6 is a diagram of an embodiment of offset distance between a first center of a pupil of each eye of the eyes of the user in the real-time eyes image and a second center of a pupil of the same eye of the eyes of the user in a standard eyes image according to the present application.

FIG. 7 is a diagram of an angle between a first imaginary line connecting an inner canthus and an outer canthus of a same eye of the user in the real-time eyes image and a second imaginary line connecting an inner canthus and an outer canthus of a same eye of the user in the standard eyes image according to the present application.

FIG. 8 is a diagram of a first embodiment of the adjustment prompting information displayed in the display module shown in FIG. 1 according to the present application.

FIG. 9 is a diagram of a second embodiment of the adjustment prompting information displayed in the display module shown in FIG. 1 according to the present application.

FIG. 10 is a flowchart illustrating an embodiment of a method of wearing detection according to the present application.

### DETAILED DESCRIPTION

To make persons skilled in the art understand the application better, the following clearly describes the technical solutions in the embodiments of this application. Apparently, the embodiments described in the following are merely some rather than all of the embodiments of this application. All other embodiments obtained by persons of ordinary skill in the art without creative efforts fall within the protection scope of this application. The following clearly describes the technical solution in embodiments of this application with reference to the accompanying drawings in the embodiments of the application. When no conflict occurs, embodiments of this application and features in the embodiments may be mutually combined.

In the description of the application, terms, such as “height”, “upper”, “lower”, “left”, “right”, “vertical”, “horizontal”, “inside”, “outside”, and so on, are based on those shown in the drawings, which is only for the convenience of describing the present application and simplifying the description, and does not indicate or imply that the referred devices or elements must have a specific orientation, or must be constructed and operated in a specific orientation, so they cannot be understood as limiting the present application.

In the description of the application, it is understood that, unless otherwise defined, meanings of all technical and scientific terms, “mount”, “connect”, “joint”, and “attach”, should be understood in a broad sense, which may be, for example, a fixed connection, a detachable connection, or an integrated connection; a direct connection or an indirect connection through an intermediate medium, or communication between the interior of two elements. For those of ordinary skill in the art, the specific meaning of the above t4erms in the present application may be understood according to specific situations. The terms, “include” and any variations thereof are intended to cover non-exclusive inclusions. For example, a process, a method, a system, a product, or a device that includes a series of steps or units is not limited to steps or units that have been listed, but optionally further includes an unlisted step or unit, or optionally further includes another step or unit inherent to the process, the method, the product, or the device.

Technologies in virtual reality (VR), augmented reality (AR), mixed reality (MR), or extended reality (XR) are new burgeoning multimedia in recent years. The VR technology are a computer emulation system of establishing and experiencing a virtual word, which form a simulation environment, for making an user to be immersed in the simulation environment. The AR technology is a technology of overlapping the virtual reality and the reality word and being interacted. The MR technology introduces virtual scene information into a real environment and builds an information path of interaction feedback among the real word, a virtual word, and the user, which increases real feelings of an user experience. Thus, the MR technology has characteristics in authenticity, in-time interactivity, and imagination. The XR covers a plurality of media technologies, such as the AR, the VR, the MR, the XR, for providing experience in immersion, interaction, and innovation.

In scenes of the AR, the VR, the MR, the XR, the user wears a head mounted display (HMD) device for watching image displayed in the HMD device, therefore an interactive immersive experience is achieved.

While using, the HMD device contacts with face of the user, and aligns a display with the eyes of the user. However, if a wearing position of the HMD device is offset, it is hard to present the images with near and far objects as in a reality word, and it is hard to determine a relative distance of the object. Further, it is easily to cause uncomfortable symptoms, such as visual fatigue and dizziness, and the user experience is affected.

Therefore, the present application provides a HMD device, for automatically detecting a wearing condition of the HMD device, which is convenience for the user to adjust a wearing position of the HMD, thus a comfortable wearability and a display effect of the HMD are improved.

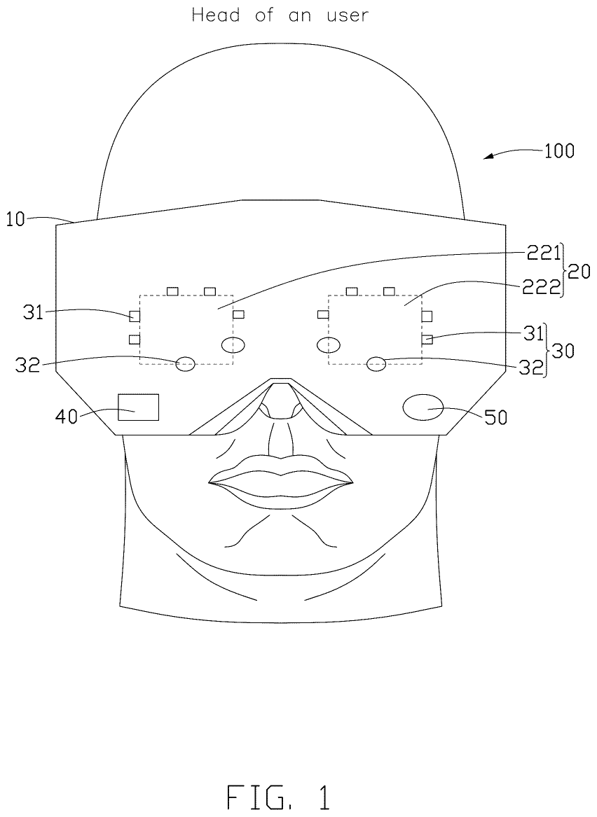

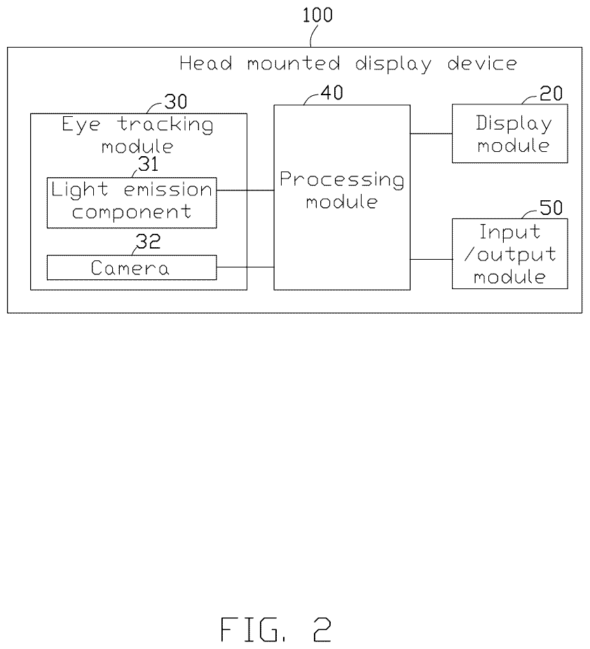

In detail, FIG. 1 shows an embodiment of an application environment of the HMD device 100 according to the present application. FIG. 2 shows a block diagram of an embodiment of the HMD device 100 according to the present application.

As shown in FIG. 1, the HMD device 100 is wore on a head of the user. The HMD device 100 may be a smart glasses. The smart glasses may be AR glasses, VR glasses, MR glasses, or XR glasses. The smart glasses are configured to apply fields in recreation, education, medical, and so on. For example, in the field of recreation, using the smart glasses, it allows the user to being present in recreation activities, such as being present a game, watching a movie, and so on. In the field of education, the smart glasses further may be used as a learning tool. Using different manners, such as simulating an experiment or reproducing a scene, a learning environment is provided for students. In the field of medical, the smart glasses are applied in aspects, such as remote medical or real-time diagnosis. A doctor may wear the smart glasses for obtaining a real-time data of a patient.

It is understood that, in other embodiments, the HMD device 100 also may be a smart helmet or a smart mask, and other types of AR/VR/MR/XR terminal devices.

Further, as shown in FIG. 1, the HMD device 100 includes a supporting body 10. When the HMD device 100 is the smart glasses, the supporting body 10 is a glasses frame. When the HMD device 100 is the smart helmet, the supporting body 10 is a helmet body sleeved on a head of the user. When the HMD device 100 is the smart mask, the supporting body 10 is a mask body covering the face of the user.

As shown in FIGS. 1 and 2, the HMD device 100 also includes a display module 20, an eye tracking module 30, and a processing module 40, which are disposed on the supporting body 10.

The display module 20 is configured to display a virtual predefined image or partial of the virtual predefined image, for the user to watch. For example, the predefined image may be an image under a scene of a game, also may be an image with arrows indicating a movement along a left and a right directions, arrows indicating a movement along an upper and a lower directions, or an arrow indicating rotation along a predefined direction, and others too numerous to list.

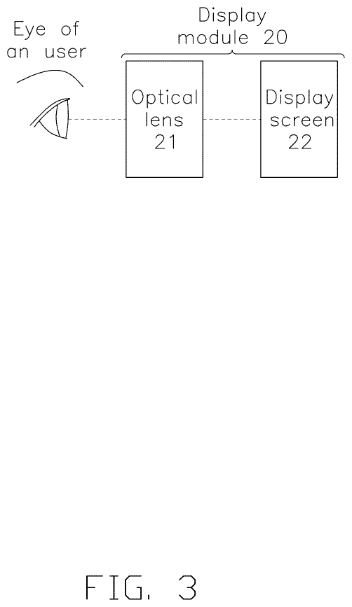

As shown in FIG. 3, the display module 20 may include optical lenses 21 and display screens 22. The optical lenses 21 are disposed on a path of outputting the image of the corresponding display screen 22. For example, after the user puts on the HMD device 100, the optical lenses 21 are disposed between the corresponding display screen 22 and one eye of the user, and are configured to project the image displayed by the display module 20 into the eyes of the user.

There are two display screens 22, and both of the display screens 22 are served as display regions 221. It is understood that, in other embodiments, the two display regions 221 may be two different position regions in one display screen 22. When the supporting body 10 is put on the head of the user, the display regions 221 face to the eyes of the user, and correspond to the eyes of the user respectively.

The eye tracking module 30 may be disposed on the display module 20, and is configured to capture an eyes image of the user at a time point t1 as an real-time eyes image.

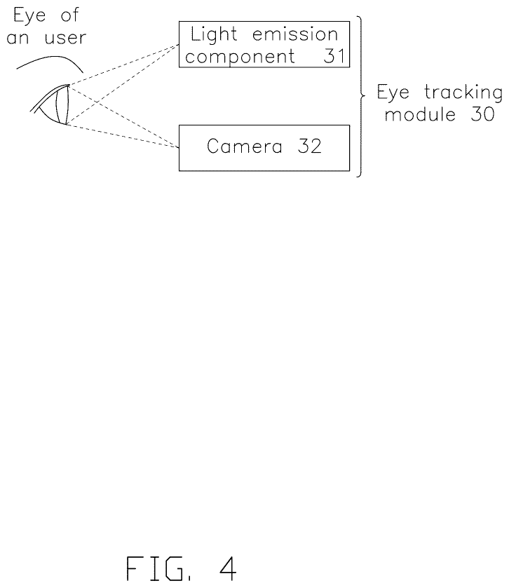

As shown in FIG. 1, the eye tracking module 30 includes light emission components 31 and cameras 32. The light emission components 31 and the cameras 32 are disposed on edges of the display region 221. The light emission components 31 may be light emitting diode (LED) or LED array. As shown in FIG. 4, the light emission components 31 are configured to convert electrical signals into light and externally emit. The light signals are served as incident ray, and reflect by the eyes. The reflected light (called as reflection ray) are received by the cameras 32, and an eyes image is formed after being algorithm processed.

The light may be infrared (IR) ray. A wavelength of the light is in a range of infrared light, but not being specifically limited. Correspondingly, the cameras 32 may be infrared cameras. The number of the light emission components 31 and the cameras 32 are not specially limited. For example, in one embodiment, there are at least two light emission components 31 and at least two cameras 32. Under a scene with a lower requirement in image resolution and details, some of the light emission components 31 and the cameras 32 work. Under a scene with a higher requirement in image resolution and details, more light emission components 31 and more cameras 32 work or all of the light emission components 31 and the cameras 32 work.

The processing module 40 is disposed on the supporting body 10. The processing module 40 is electrically connected or communicated with the eye tracking module 30 and the display module 20 respectively. The processing module 40 may be a microcontroller unit (MCU), or other processing chip or controlling chip.

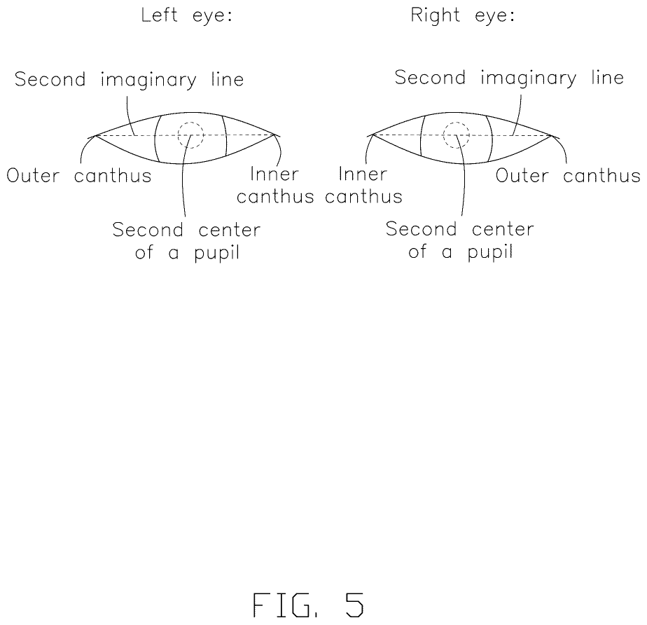

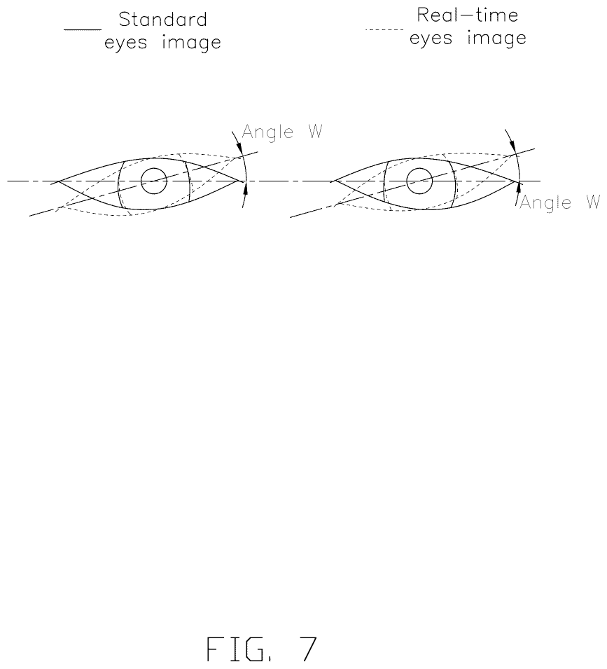

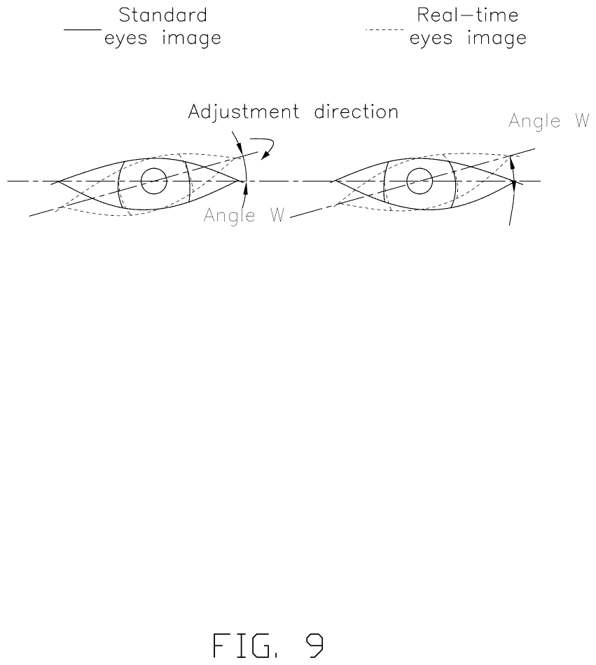

Further, the processing module 40 is configured to calculate a first center of a pupil of each eye of the user in the real-time eyes image, and a first imaginary line connecting an inner canthus and an outer canthus of each eye of the user in the real-time eyes image (as the dot dash line shown in FIGS. 7 and 9). The processing module 40 is further configured to calculate a second center of a pupil of each eye of the user in the standard eyes image, and a second imaginary line connecting an inner canthus and an outer canthus of each eye of the user in a predefined standard eyes image (as the broken line shown in FIG. 5 and the dot dash lines shown in FIGS. 7 and 9).

Referring to FIG. 5 again, when the user looks straight ahead, the first center of the pupil each eye of the user in the real-time eyes image is located at a center position of the eyes. Referring to FIG. 3, the first center of the pupil of each eye and an optical center of the corresponding optical lens 21 are positioned on a same line, which is perpendicular to the corresponding display screen 22. The first center of the pupil of each eye corresponds to a center position of the display region 221, which corresponds to the corresponding eye. Under this condition, the eyes may achieve a clearest and most comfortable state while watching objects.

Referring to FIG. 5 again, the first imaginary line is a line connected the inner canthus and the outer canthus of a same eye of the user. When the user looks straight ahead, the first imaginary line passes through the center of the pupil of each eye respectively.

The processing module 40 may use image processing algorithm (such as edge detection algorithm or Transformer model, and so on) to process the real-time eyes image, thus feature points corresponding to the first center of the pupil, the inner canthus, and the outer canthus, in the eyes image, of the user in the real-time image, are obtained. The first imaginary line of each eye is obtained by connecting the feature points of the inner canthus and the outer canthus of a same eye in the real-time eyes image.

The standard eyes image may be eyes image while the user looks straight ahead. The processing manner of the standard eyes image may refer to the real-time eyes image, and is not described repeatedly herein.

Further, the processing module 40 may be configured to calculate an offset distance D between the first center of the pupil of the each eye of the user in the real-time eyes image and the second center of a pupil of corresponding eye in the standard eyes image.

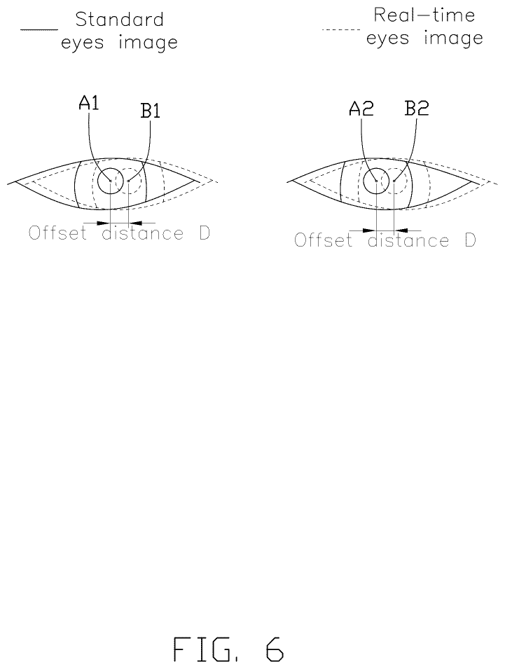

Referring to FIG. 6, the broken lines in FIG. 6 represent the eyes in the real-time eyes image, and the solid lines represent the eyes in the standard eyes image. A center A1 represents the second center of the pupil of the left eye in the standard eyes image, and a center A2 represents the second center of the pupil of the right eye in the standard eyes image. A center B1 represents the first center of the pupil of the left eye in the real-time eyes image, and a center B1 represents the first center of the pupil of the right eye in and the real-time eyes image. The distance between the center A1 and the center B1 represents to the offset distance D corresponding to the left eye, and distance between the center A2 and the center B2 represents to the offset distance D corresponding to the right eye. A direction of the offset distance D is not being limited, for example, one a horizontal direction, the offset distance D is a horizontal distance, for another example, on a vertical direction, the offset distance D is a vertical distance.

The processing module 40 further calculates an angle W between the first imaginary line connecting the inner canthus and the outer canthus in the real-time eyes image and the second imaginary line connecting the inner canthus and the outer canthus in the standard eyes image corresponding to a same eye. The angle W between the first imaginary line of the left eye in the real-time eyes image and the second imaginary line of the left eye in the standard eyes image and the angle W between the first imaginary line of the right eye in the real-time eyes image and the second imaginary line of the right eye in the standard eyes image are calculated.

The angle W is a rotation angle of the first imaginary line in the real-time eyes image being rotated along a predefined direction (for example a clockwise direction) to be overlapped with the corresponding second imaginary line in the standard eyes image. For example, referring to FIG. 7, the angle W may be in a range from −360 degree to +360 degree. “−” and “+” represent two different rotation directions, such as a clockwise direction and an anticlockwise direction respectively.

Further, the processing module 40 may further determine whether the offset distance is larger than a predefined distance threshold, and determine whether the angle is larger than a predefined angle threshold.

The predefined distance threshold may be a specified value, and also may be a value range, which is adjustable according to sizes and shapes of the eyes of the users, but not being limited. The predefined angle threshold is similar to the predefined distance threshold. For example, the predefined distance threshold and the predefined angle threshold are obtained by a test of wearing the HMD device 100 for multiple times. The predefined distance threshold may be a set as 5 mm±5 mm×3%, and the predefined angle threshold may be set as 5°±5°×3%.

In a condition that, the offset distance D of each eye is less than or equal to the predefined distance threshold, and the angle W of each eye is less than or equal to the predefined angle threshold, it is determined that the real-time eyes image is almost overlapped with the standard eyes image, the wearing position of the HMD device 100 is correct, and is in a best position. Under this condition, the eyes of the users are in a best comfortable state, and a visual effect is best.

Conversely, in a condition that, the offset distance D of at least one eye is larger than the predefined distance threshold, it is determined that the offset distance D is excessive. In a condition that, the angle W of at least one eye is larger than the predefined angle threshold, it is determined that the angle is excessive. Under this condition, it is determined that the real-time eyes image is not almost overlapped with the standard eyes image. The wearing position of the HMD device 100 is incorrect, and is not in the best position. While watching objects, there is double image. Therefore, a visual fatigue and dizziness will be caused.

Thus, in a condition that, the offset distance D is larger than the predefined distance threshold and/or the angle W of at least one eye is larger than the predefined angle threshold, the processing module further configured to output adjustment prompting information. The adjustment prompting information is configured to prompt the user to adjust the wearing position of the HMD device 100, for assisting the user to effectively adjust the wearing position of the HMD device 100.

In a condition that, the offset distance D of each eye is less than or equal to the predefined distance threshold and the angle W of each eye is less than or equal to the predefined angle threshold, there is no need to adjust the wearing position of the HMD device 100. Thus, the processing module 40 stops outputting the adjustment prompting information.

It is understood that, in some embodiments, the processing module 40 may only calculate the offset distance D and the angle W of the left eye, and outputs the adjustment prompting information in a condition of the offset distance D of the left eye being less than or equal to the predefined distance threshold and the angle W of the left eye being less than or equal to the predefined angle threshold. Or, the processing module 40 may calculate the offset distance D and the angle W of the right eye, and outputs the adjustment prompting information in a condition of the offset distance D of the right eye being less than or equal to the predefined distance threshold and the angle W of the right eye being less than or equal to the predefined angle threshold.

In some embodiments, the processing module 40 is configured to output the adjustment prompting information to the display module 20 for displaying the adjustment prompting information on the display module 20.

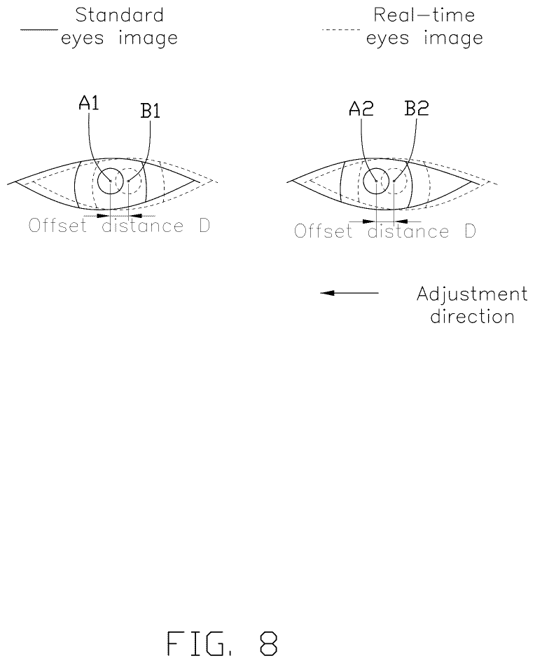

In one embodiment, as shown in FIGS. 8 and 9, the display regions 221 may display the adjustment prompting information. The adjustment prompting information includes an adjustment direction of the HMD device 100, which is an arrow in FIGS. 8 and 9. At the same time, the display region 221 may also display the real-time eyes image and the standard eyes image, for comparing with each other, and it is convenience to the user to check and adjust.

For example, in a condition that, the offset distance D along the horizontal direction is larger than the predefined distance threshold, and the angle W is larger than the predefined angle threshold, the HMD device 100 may firstly display the image in FIG. 8, and prompt the user to adjust the wearing position of the HMD device 100 for decreasing the offset distance D, until the offset distance D is less than or equal to the predefined angle threshold. At this moment, the first pupil centers of the real-time eyes image are overlapped with the second pupil centers of the standard eyes image. It is determined that, the eyes of the user may be aligned with the display region 221. The HMD device 100 stops prompting the user to adjust the offset distance D.

Then, the HMD device 100 displays the image shown in FIG. 9, and prompts the user to adjust the wearing position of the HMD device 100. Until the angle W is less than or equal to the predefined angle threshold. At this moment, the first imaginary line in the real-time eyes image is overlapped with the second imaginary line in the standard eyes image. It is determined that, the user may look straight ahead the display region 221, and the pupil center of the eyes corresponds to the center position of the display region 221. The pupil center of the eyes and the optical center of the optical lens 21 are positioned on a same line, and the HMD device 100 stops prompting the user to adjust the angle W.

It is understood that, the adjustment of the HMD device 100 may be shifted or rotated. Further, the HMD device 100 includes a position adjustment mechanism. The position adjustment mechanism is configured to shift or rotate the display module 20, for adjusting the wearing position of the HMD device 100.

Certainly, in other embodiments, the angle W may be adjusted firstly, and then the offset distance D is adjusted.

In another embodiment, the adjustment prompting information further includes an adjustment amplitude. For example, the adjustment distance is displayed on the arrow shown in FIG. 8, and the adjustment angle is displayed on the arrow shown in FIG. 9.

In some embodiments, as shown in FIGS. 1 and 2, the HMD device 100 further includes an input/output module 50. The input/output module 50 is disposed on the supporting body 10, and is electrically connected or communicated with the processing module 40.

In one embodiment, the input/output module 50 may include speakers and microphones. The processing module 40 may be configured to output the adjustment prompting information to the speakers, for playing the adjustment prompting information. The processing module 40 further receives controlling instructions translated the received voice by the microphones, and execute a corresponding control or process according to the controlling instructions.

The controlling instructions are not being limited. For example, the controlling instructions may control the two display regions 221 to display the image at the same time, or control one of the display region 221 to display the image. In another example, the controlling instructions may control the two eye tracking module 30 corresponding to the display regions 221 the to work at the same time, or control one of the two eye tracking module 30 corresponding to the display regions 221 the to work.

In another embodiment, the input/output module 50 may further includes a communication unit. The communication unit may be a wireless communication unit. The processing module 40 is further configured to receive the controlling instructions by the communication unit, which are from a mobile terminal device of the user, and execute a corresponding control or process according to the controlling instructions. The processing module 40 is further configured to output the adjustment prompting information to the mobile terminal device of the user through the communication unit, which is displayed in the mobile terminal device of the user.

Besides, in some embodiments, the processing module 40 is further configured to update and correct the standard eyes image.

In detail, when the user firstly wears the HMD device 100, that is the HMD device 100 initially work. The processing module 40 may set the eyes image sample of factory settings as the standard eyes image for calculating the offset distance D and the angle W. During an initial process of the HMD device 100, the processing module 40 may detect the wearing positions and output the adjustment prompting information for a plurality of times. The offset distance D and the angle W are calculated at a preset time interval in the initial process.

In a condition that, the offset distance D at each of the preset time interval is less than or equal to the predefined distance threshold, and the angle W at each of the preset time interval is less than or equal to the predefined angle threshold, it is determined that the wearing position of the HMD device 100 is stable and is in the best wearing position. Thus, the processing module 40 updates the initial real-time eyes image as the standard eye image, and the correction of the standard eyes image is completed. The preset time interval may be set according to actual condition, for example, based on the preset time interval, the operation of calculating the offset distance D and the angle W are executed for 10 times during the initial process.

In a condition that, the offset distance D at any preset time interval is less than or equal to the predefined distance threshold, and the angle W at any preset time interval is less than or equal to the predefined angle threshold, it is determined that the wearing position is unstable and is not in the best wearing position. Thus, the processing module 40 may detect the wearing position and output the adjustment prompting information, until the correction of the standard eyes image is completed.

After that, in each time the HMD device 100 works, the real-time eyes image in the initial process is served as the standard eyes image. Under this design, according to different users, the difference in sizes and shapes of the eyes, the initial real-time eyes image may fit the different users, thus the wearing detection accuracy of the HMD device 100 is improved. It is benefit to improve the accuracy and the efficiency of the wearing position of the HMD device 100.

On the whole, the HMD device 100 of the present application uses the display module 20, the eye tracking module 30, and the processing module 40 for achieving an automatic detection of the wearing condition of the HMD device 100. The HMD device 100 further provides adjustment prompting information corresponding to the wearing position, for allowing the user to adjust the wearing position of the HMD device 100 effectively. Therefore, the wearing comfort and display effect of the HMD device 100 are improved.

The HMD device 100 of the present application may detect whether the offset distance of the first and second pupil centers of a same eye in the real-time eyes image and the standard eyes image is excessive, for determining whether the real-time eyes image is shifted in the upper and lower directions or in the left and right directions. The HMD device 100 of the present application further detect whether the angle between the first and second inner and outer canthus lines of a same eye in the real-time eyes image and the standard eyes image is excessive, for determining whether the real-time eyes image is shifted in a view angle. Based on this, whether the wearing position of the HMD device 100 is in the best wearing position is comprehensively determined. The wearing position of the HMD device may be fully and accurately detected. Therefore, the accuracy and the efficiency of the wearing position of the HMD device 100 is improved.

The HMD device 100 of the present application prompts the user to adjust the HMD device 100 along the upper and lower directions, the left and right directions, and the rotation direction in 360 degrees. Therefore, the adjustment of the wearing position of the HMD device 100 of the present application may be more fine and accuracy.

Based on the HMD device 100, the present application also provide a method of wearying detection of the HMD device 100. After the user puts the HMD device 100, the HMD device 100, the processing module 40 in the HMD device 100 executes the method of wearying detection of an embodiment of the present application, and detect the wearing condition of the HMD device 100 and assist the user to adjust the HMD device 100, for improving the comfortable wearability and the display effect of the HMD device.

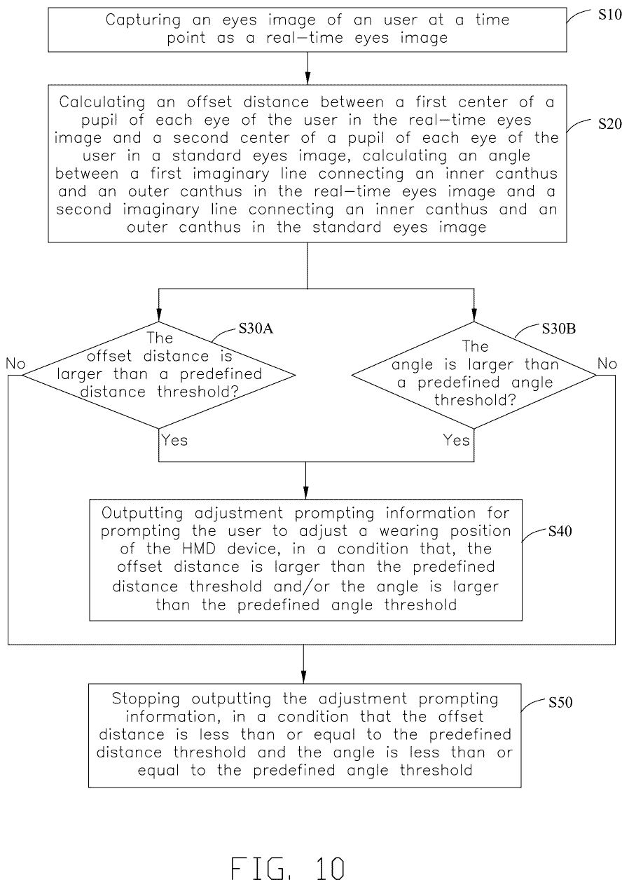

Specifically, referring to FIG. 10, the method of wearying detection of an embodiment of the present application includes the following steps.

In block S10, real-time eyes image of an user at a time point t1 is captured as the real-time eyes image.

The processing module 40 may capture the real-time eyes image by the eye tracking module 30.

In block S20, the offset distance D between the first center of a pupil of an eye of the eyes of the user in the real-time eyes image and a second center of a pupil of a same eye of the eyes of the user in the standard eyes image is calculated and the angle W between the first imaginary line connecting an canthus and an outer canthus of a same eye in the real-time eyes image and a second imaginary line connecting an canthus and an outer canthus of a corresponding eye of the user in the standard eyes image is calculated, based on the real-time eyes image and the standard eyes image.

The offset distance D may refer to FIG. 6. The first and second imaginary lines are lines connecting the inner canthus and outer canthus of a same eye. The angle W between the first and second imaginary lines may refer to FIG. 7.

In block S30A, determining whether the offset distance D is larger than the predefined distance threshold.

In block S30B, determining whether the angle W is larger than the predefined angle threshold.

In block S40, in a condition that, the offset distance D is larger than the predefined distance threshold, and/or the angle is larger than the predefined angle threshold, the adjustment prompting information is outputted. The adjustment prompting information is configured to prompt the user to adjust the wearing position of the HMD device 100.

The adjustment prompting information includes an adjustment direction, and/or includes the adjustment direction and an adjustment amplitude.

The process of outputting the adjustment prompting information includes:

The adjustment prompting information is outputted to the display module 20, for displaying the adjustment prompting information on the display module 20.

And/or, the adjustment prompting information is outputted to the speakers, for playing the adjustment prompting information on the speakers.

And/or, the adjustment prompting information is outputted to the mobile terminal device of the user, for displaying the adjustment prompting information on the mobile terminal device.

In block S60, in a condition that, the offset distance D is less than or equal to the predefined distance threshold and the angle is less than or equal to the predefined angle threshold, the adjustment prompting information is stopped outputting.

In the present application, the method of wearing detection may further include the following steps.

During an initial process of the HMD device 100, the eyes image sample of factory settings is set as the standard eyes image. The offset distance D and calculate the angle W are calculated at a preset time interval during the initial process.

When the offset distance D at each of the preset time interval is less than or equal to the predefined distance threshold, and the angle W at each of the preset time interval is less than or equal to the predefined angle threshold, the real-time eyes image in the initial process is updated as the standard eye image, for using in later wearing detection.

It is understood that, the foregoing embodiments, to facilitate description, they are all expressed as a series of action combinations, but a person having an ordinary skill in the art should be aware that the present application is not limited by the described order of actions, because some steps may be performed in other orders or simultaneous according to the present application.

The present application is not limited to the above specific embodiments. Those skilled in the art will easily understand that there are many alternatives to the electronic device 100 of the present application without departing from the principles and scope of the present application. The scope of the present application is subject to the contents of the claims.

What is claimed is:

1. A head mounted display (HMD) device comprising:
a supporting body;
a display module, disposed on the supporting body;
an eye tracking module, disposed on the supporting body, the eye tracking module configured to capture an image of eyes of an user at a time point as a real-time eyes image; and
a processing module, disposed on the supporting body and electrically connected with the display module and the eye tracking module,
wherein the processing module is configured to:
calculate an offset distance between a first center of a pupil of each eye of the user in the real-time eyes image at the time point and a second center of the pupil of each eye of the user in a standard eyes image, and
calculate an angle between a first imaginary line connecting an inner canthus and an outer canthus of each eye in the real-time eyes image at the time point and a second imaginary line connecting an inner canthus and an outer canthus of each eye in the standard eyes image;
wherein in a condition that the offset distance is larger than a predefined distance threshold and/or the angle is larger than a predefined angle threshold, the processing module is further configured to output adjustment prompting information being configured to prompt the user to adjust the HMD device.

2. The HMD device of claim 1, wherein the adjustment prompting information comprises an adjustment direction of the HMD device.

3. The HMD device of claim 1, wherein the processing module is further configured to constructing the standard eye image by:
calculating the offset distance and calculate the angle at a preset time interval;
determining whether the offset distance at each of the preset time interval is less than or equal to the predefined distance threshold;
determining the angle at each of the preset time interval is less than or equal to the predefined angle threshold;
in a condition that, the offset distance and the angle at each of the preset time interval are respectively less than or equal to the predefined distance threshold and the predefine angle continuously for a predefined time, updating the image of the eyes at the time point t1 as the standard eyes image.

4. The HMD device of claim 1, wherein in a condition that, the offset distance is less than or equal to the predefined distance threshold and the angle is less than or equal to the predefined angle threshold, the processing module is further configured to stop outputting the adjustment prompting information.

5. The HMD device of claim 1, wherein the HMD device further comprises:
speakers, disposed on the supporting body and electrically connected with the processing module;
the processor module is further configured to format the adjustment prompting information in an audio format and to output the adjustment prompting information to the speakers to play the adjustment prompting information.

6. The HMD device of claim 1, wherein the HMD device further comprises:
microphones, disposed on the supporting body and electrically connected with the processing module;
wherein the microphones is configured to receive voice of the user and to translate the voice into controlling instructions, and the processing module is further configured to execute a corresponding control or a corresponding process according to the controlling instructions.

7. The HMD device of claim 1, wherein the eye tracking module comprises light emission components and cameras; each of the light emission components is configured to emit an incident ray; a reflection ray is formed by the incident ray reflected by the eyes of the user; the cameras is configured to receive the reflection ray to form the image of the eyes.

8. The HMD device of claim 1, wherein the display module comprises optical lenses and at least one display screen; an optical center of the optical lens and the center of the pupil of a corresponding eye are aligned.

9. The HMD device of claim 1, wherein the predefined distance threshold is in a range of 5 mm±5 mm×3%.

10. The HMD device of claim 1, wherein the predefined angle threshold is in a range of 5°±5°×3%. 11. A method of wearing detection, performed by a head mounted display (HMD) device, the HMD device comprises a supporting body, a display module, an eye tracking module, and a processing module; the processing module executes computer programs to perform the following instructions:
capturing an eyes image of an user at a time point as an real-time eyes image;
calculating an offset distance between a first center of a pupil of each eye of the user in the real-time eyes image and a second center of a pupil of each eye of the user in a standard eyes image, and calculating an angle between a first imaginary line connecting an inner canthus and an outer canthus of each eye in the real-time eyes image and a second imaginary line connecting an inner canthus and an outer canthus of each eye in the standard eyes image; and
in a condition that the offset distance is larger than a predefined distance threshold and/or the angle is larger than a predefined angle threshold, outputting adjustment prompting information being configured to prompt the user to adjust a wearing position of the HMD device.

12. The method of claim 11, wherein the adjustment prompting information comprises an adjustment direction of the HMD device.

13. The method of claim 11, further comprising:
calculating the offset distance and calculate the angle at a preset time interval;
determining whether the offset distance is less than or equal to the predefined distance threshold;
determining the angle is less than or equal to the predefined angle threshold;
in a condition that, the offset distance and the angle at each of the preset time interval are respectively less than or equal to the predefined distance threshold and the predefine angle continuously for a predefined time, updating the image of the eyes at the time point t1 as the standard eyes image.

14. The method of claim 13, wherein based on the preset time interval, the operation of calculating the offset distance and the angle are executed for 10 times during an initial process.

15. The method of claim 11, further comprising:
in a condition that, the offset distance is less than or equal to the predefined distance threshold and the angle is less than or equal to the predefined angle threshold, stopping outputting the adjustment prompting information.

16. The method of claim 11, wherein the HMD device further comprises speakers disposed on the supporting body; the adjustment prompting information is played by the speakers.

17. The method of claim 11, wherein the HMD device comprises an eye tracking module; the eye tracking module comprises light emission components and cameras; each of the light emission components is configured to emit an incident ray; a reflect ray is formed by the incident ray reflected by the eyes of the user; the cameras is configured to receive the reflection ray to form the real-time eyes image.

18. The method of claim 11, wherein the HMD device comprises a display module; the display module comprises optical lenses and at least one display screen; an optical center of the optical lens and the first and second center of the pupil of a corresponding eye are aligned.

19. The method of claim 11, wherein predefined distance threshold is in a range of 5mm±5mm×3%.

20. The method of claim 11, wherein the predefined angle threshold is in a range of 5°±5°×3%.
